(19) United States
(12) Patent Application Publication
(10) Pub. No.: US 2007/0049513 A1
(43) Pub. Date: Mar. 1, 2007

(54) Process for making a detergent composition

(76) Inventor: Michel Jan DeRuijter, Mechelen (BE)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/574,610

(22) PCT Filed: Sep. 20, 2004
(86) PCT No.: PCT/EP04/10632

§ 371 Date: Apr. 4, 2006

(30) Foreign Application Priority Data
Oct. 4, 2003 (GB) 0323273.3

(51) Int. Cl. C11D 17/00

(52) U.S. Cl. 510/446

(57) ABSTRACT

A continuous process for making a particulate detergent composition or component is provided. The process comprises feeding starting materials comprising a surfactant acid precursor and a particulate alkaline neutralising agent into a mixer/granulator to produce a granulated product stream, characterised in that a fraction of the product stream is cooled and recycled into the mixer/granulator.

### TECHNICAL FIELD

The present invention relates to a continuous process for making a particulate detergent composition.

### BACKGROUND AND PRIOR ART

Modern particulate laundry detergent compositions are made in a variety of ways. There is the traditional spray drying process, which is still widely used, and produces low to medium bulk density powder. The main alternative to this is to directly granulate starting components. This latter process is often carried out in a mixer/granulator with rotating blades and possibly choppers. Such granulators produce a higher bulk density due to the greater impact forces within the machinery. Such granulation processes do not suffer the economic problem of evaporating large amounts of water and can be made on a smaller scale with greater economic flexibility.

In granulation processes it was realised that addition of a surfactant acid precursor as a starting material, to be subsequently neutralised by an alkaline particulate starting material in-situ, provided many advantages over addition of a surfactant paste. Such pastes often contain a significant quantity of water, which would need to be dried off, and this alternative process avoids that extra step.

However, a potential problem with what is sometimes referred to as ‘dry-neutralisation’ is the inevitable increase in processing temperature, which is caused by the exothermic neutralisation reaction. This rise in temperature carries with it a number of disadvantages and various solutions have already been attempted. Among the proposed solutions are to partially preneutralise the surfactant acid (e.g. in EP-A-0 641 380) or to use a cooling jacket (e.g. in EP-A-0 352 135). However partial preneutralisation does not apply to all surfactant types and cooling is not efficient especially for a continuous process.

A controlled temperature can deliver benefits because the intermediate viscosity of the paste generated in-situ can also be controlled. In additions a greater range of surfactants is processable such as those that are heat-sensitive.

WO 96/09370 discloses a process for making granular detergent compositions, which has a recycle stream but wherein the surfactant is fed in as a preneutralised paste.

U.S. Pat. No. 6,576,605 recycles to a mixer the fines from a fluid bed apparatus for drying/cooling from the data given in example 1 the percentage of the feed material that comprises the recycle is about 25%, no temperatures are given and the purpose of recycling appears to be to increase surface area and not to cool.

WO 0017304 discloses in example 1 a recycle up to 20% of cooled material. The temperatures given appear to show that stage 1 operates at 60° C. and the recycle is at ambient temperature.

### DETAILED DESCRIPTION OF THE INVENTION

The present inventors have now found that use of a cooled recycle stream can provide great flexibility in control of the granulation temperature.

Thus, the present invention provides a continuous process for making a particulate detergent composition or component which comprises feeding starting materials comprising a surfactant acid precursor and a particulate alkaline neutralising agent into a mixer/granulator to produce a granulated product stream, characterised in that a fraction of the product stream is cooled and recycled into the mixer/granulator.

The Process

In the first step of the process according to the invention, the starting materials are thoroughly mixed in a mixer/granulator for a relatively short time, preferably under conditions whereby the starting material is brought into, or maintained in, a deformable state.

In the mixer/granulator the acid precursor of the surfactant is added. It is almost instantly mixed with the particulate alkaline neutralising agent and the neutralisation reaction begins. The amount of free water present is believed to be very important for the reaction speed. The term “free water” is used herein to indicate water that is not firmly bound as water of hydration or crystallisation to inorganic materials. If an insufficient amount of free water is present, the neutralisation reaction will proceed slowly or not at all and the reaction mixture leaving the high-speed mixer/granulator will still contain substantial amounts of unreacted acid precursor of the anionic surfactant. This may cause agglomeration of the powder or even dough formation.

The particulate alkaline neutralising agent may already contain sufficient free water for these conditions to be attained. If insufficient free water is present, a carefully controlled amount of water should be added in the mixer/granulator, either admixed with the acid precursor or added separately.

It is particularly preferred that the process comprises two mixer/granulators in series. In this embodiment, the product stream may be the product from either of the two mixer/granulators. Therefore the recycle stream can originate from either or both of the product streams. However it is preferred that the product stream from the second granulator provides the recycle stream. Of course, if the recycle stream is taken from the product of the second mixer/granulator it may be fed back to either or both of the mixer/granulators.

The Starting Materials

The present invention requires that some acid precursor of surfactant and some particulate alkaline neutralising agent be added to the mixer/granulator as starting materials.

Preferably, these are added as two separate feed streams. In addition, there may be further feed streams. If present as separate feed streams then it is preferred that a first feed stream comprises at least 10 wt % of surfactant acid precursor and a second feed stream comprises a particulate alkaline neutralising agent. In this embodiment it is preferred that the first feed stream comprises at least 20 wt % of surfactant acid, preferably at least 40 wt %, more preferably at least 60 wt %, or even possibly substantially all surfactant acid.

Apart from the acid precursor of the surfactant, other liquid components may also be introduced in the high-speed mixer/granulator. Examples of such ingredients include nonionic surfactants and low-melting fatty acids, which may also be neutralised by the solid alkaline inorganic material to form soaps. It is also possible to add aqueous solutions of detergent components, such as fluorescers, polymers, etc., provided that the total amount of free water is kept within the desired range.

Preferably, the starting materials comprise a heat-sensitive surfactant or acid precursor thereof. By heat sensitive is meant that substantial degradation of the surfactant occurs at a temperature of 80° C. If present it is preferred that the heat sensitive surfactant is fed in as an acid precursor.

In principle, any particulate alkaline neutralising agent can be used in the present process. The preferred material is sodium carbonate, alone or in combination with one or more other water-soluble inorganic materials, for example, sodium bicarbonate or silicate. Sodium carbonate can provide the necessary alkalinity for the wash process, but it can additionally serve as a detergency builder. The invention may be advantageously used for the preparation of detergent powders in which sodium carbonate is the sole or principal builder. In this case, substantially more carbonate will be present than required for the neutralisation reaction with the acid anionic surfactant precursor.

The starting materials may comprise other compounds usually found in detergent compositions, such as builders, e.g. sodium tripolyphosphate or zeolite, surfactants, e.g. anionics or nonionics, all well known in the art. Other examples of materials which may be present include fluorescers; polycarboxylate polymers; anti-redeposition agents, such as carboxy methyl cellulose; fatty acids; fillers, such as sodium sulphate; diatomaceous earth; calcite; clays, e.g. kaolin or bentonite.

The starting material for the process of the invention may be prepared by any suitable method, such as spray-drying or dry-mixing. It is considered to be one of the advantages of the process of this invention that high bulk density detergent powders may be prepared from dry-mixed starting materials, without the need for expensive spray-drying equipment. On the other hand, it may also be desirable that one or more of the ingredients are adjuncts of liquids onto solid components, prepared by spray-drying, granulation or via in situ neutralisation in a high-speed mixer.

Acid Precursor

The acid precursor of an anionic surfactant may be selected from linear alkyl benzene sulphonic acids, alpha-olefin sulphonic acids, internal olefin sulphonic acids, fatty acid ester sulphonic acids and combinations thereof. The process of the invention is especially useful for producing compositions comprising alkyl benzene sulphonates by reaction of the corresponding alkyl benzene sulphonic acid, for instance Dobanoic acid ex Shell.

Another preferred class of anionic surfactants is primary or secondary alkyl sulphates. Linear or branched primary alkyl sulphates having 10 to 18 carbon atoms are particularly preferred. These surfactants can be obtained by sulphation of the corresponding primary or secondary alcohols, followed by neutralisation.

It is preferred however that the surfactant is heat-sensitive. For example, it may be a C12-C18 fatty alcohol sulphate, alkyl ether sulphate, glycerol ether sulphate, monoglyceride ether sulphates, monoglyceride sulphates, hydroxy mixed ether sulphates and fatty acid isethionates.

The Mixer/Granulator

Appropriate mixers for this process include the high-shear Lodige® CB machine or moderate-speed mixers such as a Lodige® KM machine. Other suitable equipment includes Drais® T160 series manufactured by Drais Werke GmbH, Germany; the Littleford mixer with internal chopping blades and turbine-type miller mixer having several blades on an axis of rotation. A mixer/granulator has a stirring action and/or a cutting action, which are operated independently of one another. Preferred types of mixer/granulators are mixers of the Fukae® FS-G series; Diosna® V series ex Dierks & Sohne, Germany; Pharma Matrix® ex. T. K. Fielder Ltd, England. Other mixers believed to be suitable for use in the process of the invention are Fuji® VG-C series ex Fuji Sangyo Co., Japan; the Roto® ex Zanchetta & Co. srl, Italy and Schugi® Flexomix granulator.

Yet another suitable mixer is the Lodige (Trade Mark) FM series (ploughshare mixers) batch mixer ex Morton Machine Col Ltd., Scotland.

The Mixer/Granulator Temperature

Because of its fast moving internals, the mixer granulator will usually approximate to an ideal stirred reactor; i.e. it will have a homogeneous temperature distribution within it. However it is emphasised that small variations in temperature may occur especially at short residence times. If this is the case then it is important only that the recycle stream has a temperature below the temperature of the mixer/granulator, which is near to the entry port of the recycle stream.

Preferably the temperature in the mixer/granulator is no greater than 100° C., preferably no greater than 80° C., more preferably between 60° C. and 80° C.

The Recycle Stream

Preferably the recycle stream immediately after separation from the product stream contains particles which have a number average particle size which is less than that of the product stream, preferably less than 50% of that of the product stream, more preferably less than 30% of that of the product stream. In this way, the product stream after the recycle stream has been extracted from it has a more narrow particle size distribution. If the recycle stream has a smaller particle size then the recycle stream may undergo further granulation to increase the particle size before re-entering the mixer/granulator.

Alternatively or additionally, the recycle stream immediately after separation from the product stream contains particles which have a number average particle size which is greater than that of the product stream, preferably greater than twice that of the product stream, more preferably greater than three times that of the product stream. If the recycle stream has a larger particle size then the recycle stream may undergo size reduction, e.g. by milling, before re-entering the mixer/granulator.

In one embodiment there are two recycle streams, one with smaller material and one with coarser material than the product stream.

The recycle stream must be returned at a temperature below that of the mixer/granulator. This may be achieved in a variety of ways such as a fluid bed, airlift or cyclone. Preferably the product stream enters a fluidised bed and an exit stream from the fluidised bed is the recycle stream.

Preferably the temperature of the recycle stream is at least 10° C. below, preferably at least 20° C. below, more preferably at least 30° C. below, more preferably at least 40° C. below, most preferably at least 50° C. below that of the mixer/granulator.

Preferably, the recycle stream has a temperature below 60° C., preferably below 50° C., more preferably below 40° C.

Because the recycle stream may have a different particle size distribution to the product stream it may also have a compositional difference. This is because some ingredients may be more concentrated in certain size fractions. In spite of this it is preferred that the recycle stream has a wt % of surfactant which is within 5%, preferably within 3%, ideally within 2%, of that of the product stream. In this way a better quality product is obtained.

The recycle stream is from 25 to 60% of the mass flow rate of the product stream, preferably from 30 to 50%.

The Product Stream

The product stream will be a partially or completely granulated stream.

As already discussed, the product stream may be treated by other processes before it is cooled, for example it may undergo further granulation. All that is required by the present invention is that a fraction of the product stream is eventually returned to the mixer/granulator and it has a temperature below that of the mixer/granulator.

### EXAMPLES

The following ingredients where charged into a Lodige CB 50 high speed mixer:

| Ingredient | Composition (%) |
|---|---|
| Acid of C12-C18 fatty alcohol | 19.9 |
| sulphate | |
| Sodium carbonate (soda light ash) | 31.0 |
| Zeolite A24 | 9.0 |
| Recycle of fines | 40.1 |

The acid is unstable and is neutralised quickly to sodium alkyl sulphate. In addition, the sodium sulphate decomposes at temperatures greater than 80° C. Fine, recycled powder is also charged into the mixer, at 40% of total mass feed. The neutralisation of the acid is exothermal (−215 kJ/kg). Because of the amount of fines recycle, the temperature of the agglomerates out of the mixer is between 60° C. and 80° C. The average particle size is 0.26 mm (number average particle size, d50). The agglomerates are transferred to a fluid bed, which is operated with ambient air. The temperature of the powder leaving the fluid bed is ambient (25° C.). A large fraction of the fines is separated and recycled to the mixer (40.1%). The particle size of the recycled powder is well below 0.3 mm. The recuperated powder has an average particle size of 0.43 mm, with 7.3% fines (<0.18 mm). The BD of the product is 550 kg/m³. The total throughput of product is 4 t/hr. The level of surfactant in the final agglomerates is measured as 35.1%. In addition, the level of sodium sulphate is measured (0.7%). Sodium sulphate is a by-product of the decomposition of fatty alcohol sulphate. Based on these results, it is calculated that only 1.6% of the surfactant or the acid precursor is decomposed during the process.

| Ingredient | Composition (%) |
|---|---|
| C12-C18 fatty alcohol sodium | 35.1 |
| sulphate | |
| Sodium sulphate | 0.7 |

1. A continuous process for making a particulate detergent composition or component which comprises feeding starting materials comprising a surfactant acid precursor of an anionic surfactant and a particulate alkaline neutralising agent into a mixer/granulator to produce a granulated product stream, characterised in that a fraction of the product stream is cooled and recycled into the mixer/granulator, the recycle stream being from 30 to 50% of the mass flow rate of the product stream and wherein the recycle stream immediately after separation from the product stream contains particles which have a number average particle size which is less than that of the product stream.

2. A process according to claim 1, wherein the temperature of the recycle stream is at least 10° C. below, preferably at least 20° C. below, more preferably at least 30° C. below, more preferably at least 40° C. below, most preferably at least 50° C. below that of the mixer/granulator.

3. A process according to claim 1 or claim 2, wherein the recycle stream immediately after separation from the product stream contains particles which have a number average particle size which is less than 50% of that of the product stream, more preferably less than 30% of that of the product stream.

4. A process as claimed in any preceding claim, wherein the recycle stream has a surfactant concentration which is within 5%, preferably within 3%, ideally within 2%, of that of the product stream.

5. A process as claimed in any preceding claim, wherein the product stream enters a fluidised bed and an exit stream from the fluidised bed is the recycle stream.

6. A process as claimed in any preceding claim, wherein the temperature in the mixer/granulator is no greater than 100° C., preferably no greater than 80° C.

7. A process as claimed in any preceding claim, wherein the starting materials comprise a first feed stream comprising at least 10 wt % of surfactant acid precursor and a second feed stream comprising a particulate alkaline neutralising agent and optionally an additional feed stream in addition to the recycle stream.

8. A process as claimed in any preceding claim, wherein the starting materials comprise a heat-sensitive surfactant or acid precursor thereof.
